(19) United States
(12) Patent Application Publication
(10) Pub. No.: US 2012/0130631 A1
(43) Pub. Date: May 24, 2012

(54) CAR NAVIGATION SYSTEM WITH DIRECTION WARNING AND METHOD THEREOF

(75) Inventor: WU-HU CHEN, SHANGHAI CITY (CN)

(73) Assignees: MITAC RESEARCH (SHANGHAI) LTD., SHANGHAI (CN); MITAC INTERNATIONAL CORP., TAOYUAN COUNTY (TW)

(21) Appl. No.: 13/043,963

(22) Filed: Mar. 9, 2011

(30) Foreign Application Priority Data
Nov. 22, 2010 (TW) 099140221

(51) Int. Cl. G01C 21/36

(52) U.S. Cl. 701/418; 701/419

(57) ABSTRACT

In a car navigation system with direction warning and a method thereof, a satellite positioning module provides a position information; a route planning unit provides a driving route by searching an electronic map database stored in a storage unit for corresponding map information based on a starting position and a target position; and a navigation unit generates driving direction information based on the position information and the driving route, retrieves a sound signal or screen signal from a direction sound module or a screen control module, respectively, corresponded to the driving direction information, and outputs the sound signal by an output unit or displays the screen signal by a display unit. The car navigation system and the method thereof serve to provide a sound warning or an image warning to remind a driver of an angle contained between the current driving road and a next road.

### FIELD OF THE INVENTION

The present invention relates to a car navigation system and a method thereof, and more particularly to a car navigation system with direction warning and a method thereof.

### BACKGROUND OF THE INVENTION

Following the growing maturation in the car navigation techniques, manufacturers have already introduced many different types of car voice navigation systems into the market to replace the conventional screen-type navigation systems, and these car voice navigation systems are of highly human-centered design.

While there are many commercially available car navigation systems that allow a user to conveniently operate by clicking to show different windows and use the voice navigation function, these car navigation systems do not provide any direction warning function whenever the driver should change to another driving direction. For example, in using a general car navigation system, a starting point is set, a satellite positioning signal is received, and navigation begins based on built-in electronic map information. A suggested driving direction is shown on a screen of the navigation system. When the car approaches a next crossing, the driver is reminded of a correct turning by voice and the screen will also display a left turn, a right turn, or a U-turn. However, the navigation system does not provide the driver with any information about the angle contained between the current driving direction and the next road, such as 345˜15 north-south, 15˜75 north-east, etc. Under this condition, an accident tends to take place when the driver is distracted from driving while talking on a cell phone, regulating the car stereo, finding something or eating something. Moreover, most general car voice navigation systems use monotonous human voice, which often fails to draw the driver's attention to the navigation information. As a result, the car voice navigation systems gradually lose their attraction for the market.

### SUMMARY OF THE INVENTION

A primary object of the present invention is to provide a car navigation system with direction warning and a method thereof, so that music is played or a screen is caused to flash or change color as a direction warning to remind a driver of a soon coming turning on the road. The direction warning by music or changing screen also makes the car navigation system more interesting for use.

To achieve the above and other objects, a first embodiment of the car navigation system with direction warning according to the present invention includes a storage unit, a direction sound module, an output unit, a satellite positioning module, a route planning unit, and a navigation unit. The storage unit has an electronic map database stored therein. The electronic map database includes a plurality of map information, each of the map information includes road information for a plurality of roads. The direction sound module provides a plurality of direction sound information. Each of the direction sound information is based on a different direction, and each of the directions corresponds or matches a sound signal. The output unit serves to output the sound signals. The satellite positioning module serves to provide a position information about a current car position. The route planning unit provides a driving route by searching the electronic map database for corresponding map information based on a starting position and a target position. Based on the position information and the driving route, the navigation unit generates driving direction information for the car and retrieves a matching sound signal based on the driving direction information. The retrieved sound signal is then output by the output unit.

In the first embodiment of the car navigation system with direction warning according to the present invention, the sound signal can further include a music file.

To achieve the above and other objects, a second embodiment of the car navigation system with direction warning according to the present invention includes a storage unit, a screen control module, a display unit, a satellite positioning module, a route planning unit, and a navigation unit. The storage unit has an electronic map database stored therein. The electronic map database includes a plurality of map information, each of the map information includes road information for a plurality of roads. The screen control module has a plurality of screen control information stored therein. Each of the screen control information is based on a different direction, and each of the directions corresponds or matches screen signal. The display unit serves to output the screen signals. The satellite positioning module serves to provide a position information about the current car position. The route planning unit plans a driving route by searching the electronic map database for corresponding map information based on a starting position and a target position. Based on the position information and the driving route, the navigation unit generates driving direction information for the car and retrieves a screen signal corresponding to the driving direction information. The retrieved screen signal is then displayed by the display unit.

In the second embodiment of the car navigation system with direction warning according to the present invention, the screen signal can cause a screen to flash, to change in brightness, or to change in color.

To achieve the above and other object, a first embodiment of the car navigation method with direction warning according to the present invention is applicable to a car navigation system with direction warning. The car navigation system with direction warning includes a storage unit, a direction sound module, an output unit, a satellite positioning module, a route planning unit, and a navigation unit. The first embodiment of the car navigation method with direction warning according to the present invention includes the steps of: providing an electronic map database stored in the storage unit of the car navigation system with direction warning, the electronic map database including a plurality of map information, and each of the map information including road information for a plurality of roads; providing a position information about the current car position by the satellite positioning module; planning a driving route by the route planning unit by searching the electronic map database for corresponding map information based on a starting position and a target position; using the navigation unit to generate driving direction information for the car based on the position information and the driving route and retrieve a sound signal from the direction sound module corresponding to the driving direction information; and outputting the sound signal by the output unit.

Preferably, the sound signal can further include a music file.

To achieve the above and other object, a second embodiment of the car navigation method with direction warning according to the present invention is applicable to a car navigation system with direction warning. The car navigation system with direction warning includes a storage unit, a screen control module, a display unit, a satellite positioning module, a route planning unit, and a navigation unit. The second embodiment of the car navigation method with direction warning according to the present invention includes the steps of: providing an electronic map database stored in the storage unit of the car navigation system with direction warning, the electronic map database including a plurality of map information, and each of the map information including road information for a plurality of roads; providing a position information about the current car position by the satellite positioning module; planning a driving route by the route planning unit by searching the electronic map database for corresponding map information based on a starting position and a target position; using the navigation unit to generate driving direction information for the car based on the position information and the driving route and retrieve a screen signal corresponding to the driving direction information; and displaying the screen signal by the display unit.

Preferably, the screen signal can cause the screen to flash, to change in brightness, or to change in color.

In the car navigation system with direction warning and a method thereof according to the present invention, the navigation unit controls the direction sound module or the screen control module to thereby provide a sound signal or a screen signal as a direction warning to remind the driver of an angle contained between the current driving road and a next road. By giving the driver the direction warning by the sound signal or the screen signal, it would also make the car navigation system more interesting for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a first embodiment of a car navigation system with direction warning according to the present invention;

FIG. 2 is a flowchart showing the steps included in a first embodiment of a car navigation method with direction warning according to the present invention;

FIG. 3 is a block diagram of a second embodiment of the car navigation system with direction warning according to the present invention; and

FIG. 4 is a flowchart showing the steps included in a second embodiment of the car navigation method with direction warning according to the present invention.

### DETAILED DESCRIPTION OF THE PREFERRED EMBODIMENTS

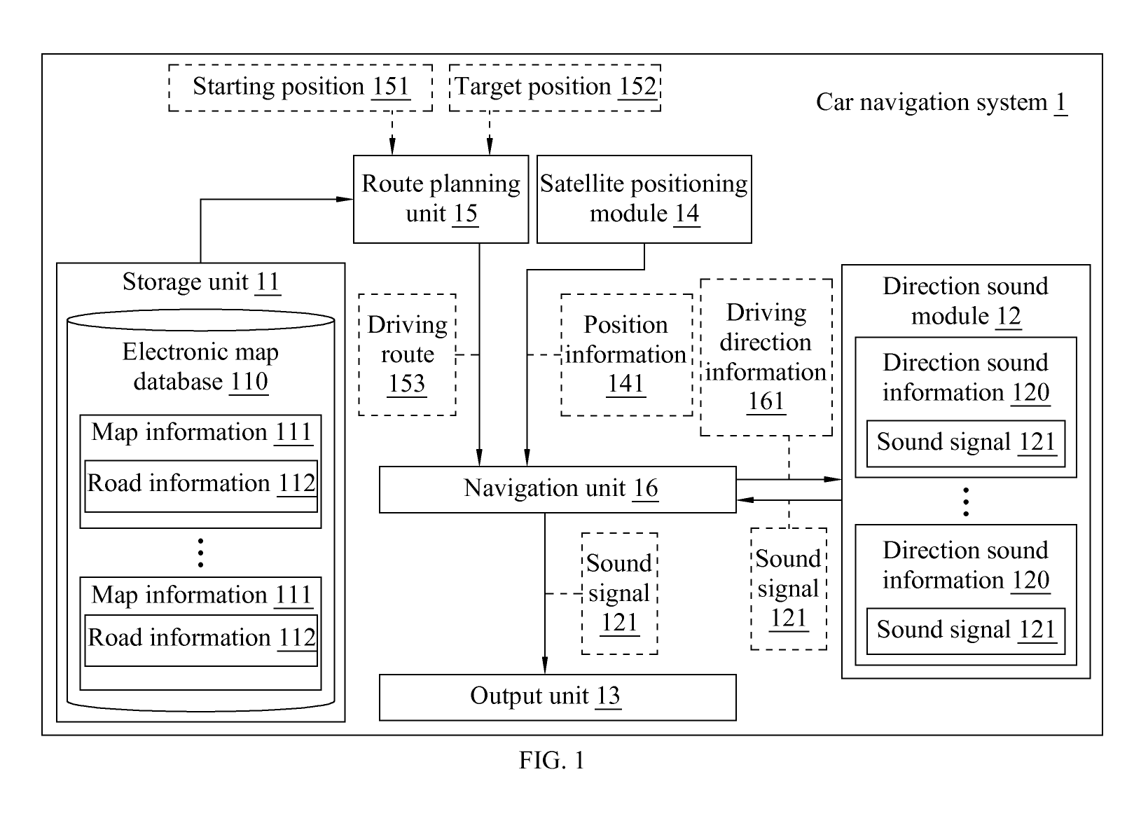

Please refer to FIG. 1 that is a block diagram of a first embodiment of a car navigation system with direction warning according to the present invention. The car navigation system with direction warning in the first embodiment is generally denoted by reference numeral 1 and will also be briefly referred to as “the car navigation system 1” herein for the purpose of conciseness. As shown, the car navigation system 1 includes a storage unit 11, a direction sound module 12, an output unit 13, a satellite positioning module 14, a route planning unit 15, and a navigation unit 16. The storage unit 11 has an electronic map database 110 stored therein. The electronic map database 110 includes a plurality of map information 111, each of the map information 111 includes road information 112 for a plurality of roads. The direction sound module 12 provides a plurality of direction sound information 120. Each of the direction sound information 120 is based on a different direction. For instance, based on the direction of north, the following directions can be defined: 345˜15 north-south, 15˜75 north-east, 75˜105 east-west, 105˜165 south-east, 165˜195 south-north, 195˜255 south-west, 255˜285 west-east, and 285˜345 north-west. Each of the directions corresponds or matches a sound signal 121. The sound signal 121 may include a music file, such as .mp3, .wav, .wma, .aac or other types of sound files. The output unit 13 serves to output the sound signals 121. The satellite positioning module 14 serves to provide a position information 141 about the current car position. The route planning unit 15 plans a driving route 153 by searching the electronic map database 110 for corresponding map information 111 based on a starting position 151 and a target position 152.

Based on the position information 141 and the driving route 153, the navigation unit 16 generates driving direction information 161 for the car and retrieves a sound signal 121 corresponding to the driving direction information 161. The retrieved sound signal 121 is then output by the output unit 13. For instance, based on an angle contained between a current driving road and a next road, the navigation unit 16 can retrieve from the direction sound module 12 a corresponding sound signal 121, which may be, for example, a music file, and plays the music via the output unit 13, which may be, for example, a speaker, so as to remind the driver to slow down and be prepared for a next turn. It is also possible for the driver to set his own music files corresponding to different directions, making the car navigation system 1 of the present invention more interesting for use.

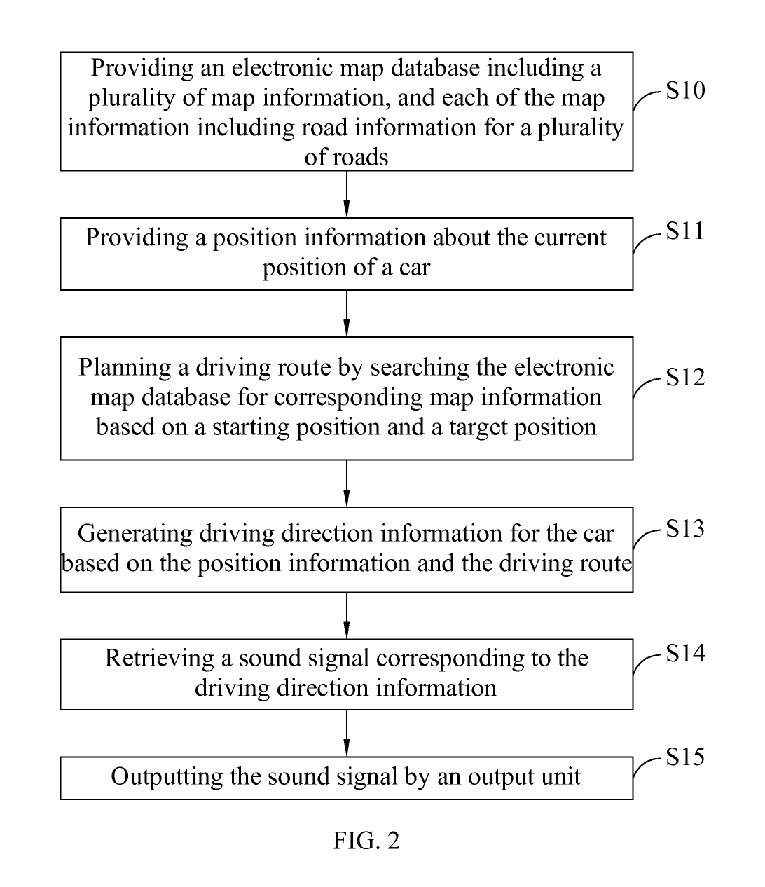

Please refer to FIG. 2 that is a flowchart showing the steps included in a first embodiment of a car navigation method with direction warning according to the present invention. According to this first car navigation method, the driver can recognize a different angle contained between the current driving road and the next road by listening to different musical signals. The method is applicable to a car navigation system with direction warning, which includes a storage unit, a direction sound module, an output unit, a satellite positioning module, a route planning unit, and a navigation unit. The car navigation method with direction warning in the first embodiment includes the following steps:

providing an electronic map database including a plurality of map information, and each of the map information including road information for a plurality of roads (S10);

providing a position information about the current car position (S11);

planning a driving route by searching the electronic map database for corresponding map information based on a starting position and a target position (S12);

generating driving direction information for the car based on the position information and the driving route (S13);

retrieving a sound signal corresponding to the driving direction information (S14); and

outputting the sound signal by the output unit (S15).

Accordingly, based on an angle contained between a current driving road and a next road, the navigation unit can retrieve from the direction sound module a corresponding sound signal, which may be, for example, a music file, and plays the music via the output unit, which may be, for example, a speaker, so as to remind the driver to slow down and be prepared for a next turn. By playing different musical signals to remind the driver of different driving directions, there is more fun in using the car navigation system of the present invention.

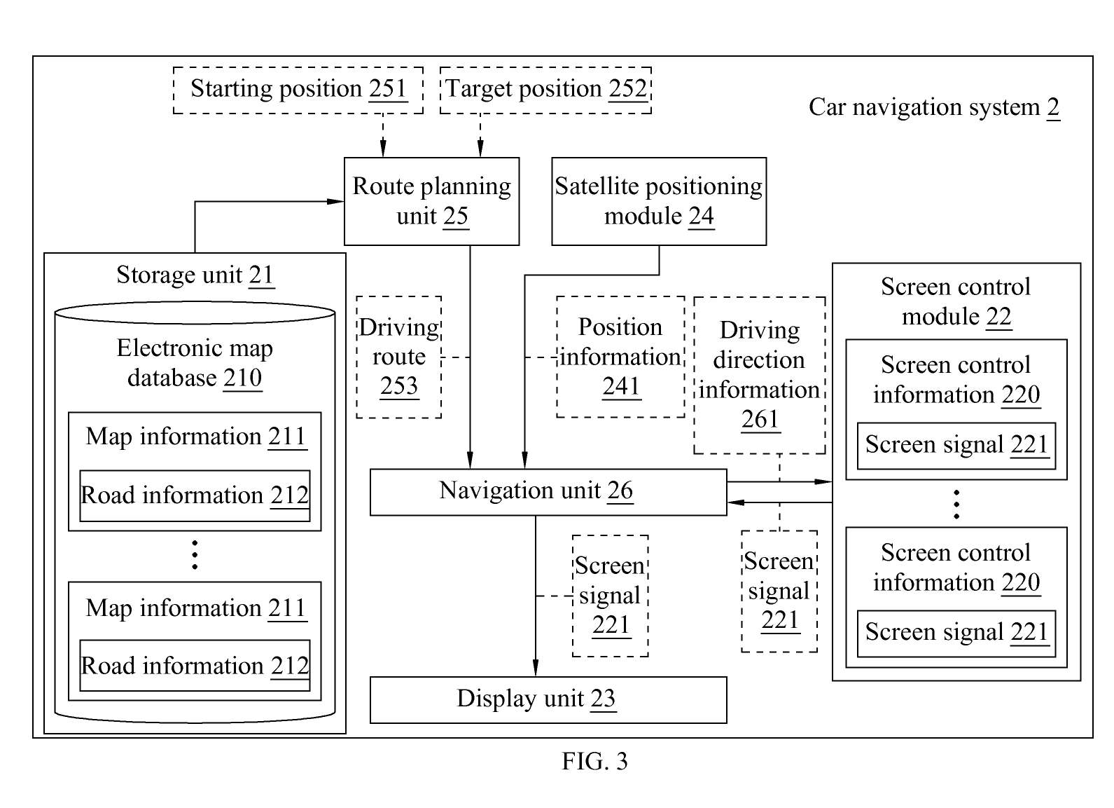

FIG. 3 is a block diagram of a second embodiment of a car navigation system with direction warning according to the present invention. The car navigation system with direction warning in the second embodiment is generally denoted by reference numeral 2 and will also be briefly referred to as “the car navigation system 2” herein for the purpose of conciseness. As shown, the car navigation system 2 includes a storage unit 21, a screen control module 22, a display unit 23, a satellite positioning module 24, a route planning unit 25, and a navigation unit 26. The storage unit 21 has an electronic map database 210 stored therein. The electronic map database 210 includes a plurality of map information 211, each of the map information 211 includes road information 212 for a plurality of roads. The screen control module 22 provides a plurality of screen control information 220. Each of the screen control information 220 is based on a different direction. For instance, based on the direction of north, the following directions can be defined: 345˜15 north-south, 15˜75 north-east, 75˜105 east-west, 105˜165 south-east, 165˜195 south-north, 195˜255 south-west, 255˜285 west-east, and 285˜345 north-west. Each of the directions corresponds or matches screen signal 221. The screen signal 221 may, for example, cause a screen to flash, to change in brightness, or to change in color. The display unit 23 serves to display the screen signals 221. The satellite positioning module 24 serves to provide a position information 241 about the current car position. The route planning unit 25 plans a driving route 253 by searching the electronic map database 210 for corresponding map information 211 based on a starting position 251 and a target position 252.

Based on the position information 241 and the driving route 253, the navigation unit 26 generates driving direction information 261 for the car and retrieves a screen signal 221 corresponding to the driving direction information 261. The retrieved screen signal 221 is then output by the display unit 23. For instance, based on an angle contained between a current driving road and a next road, the navigation unit 26 can retrieve from the screen control module 22 a corresponding screen signal 221, which may, for example, cause the screen to flash, and the display unit 23, which may be, for example, a touch screen, would flash the image shown on the screen, so as to remind the driver to slow down and be prepared for a next turn. It is also possible for the driver to set his own screen signals corresponding to different directions, such as changing the color flashing on the screen or changing the manner in which the screen flashes, making the car navigation system 2 of the present invention more interesting for use.

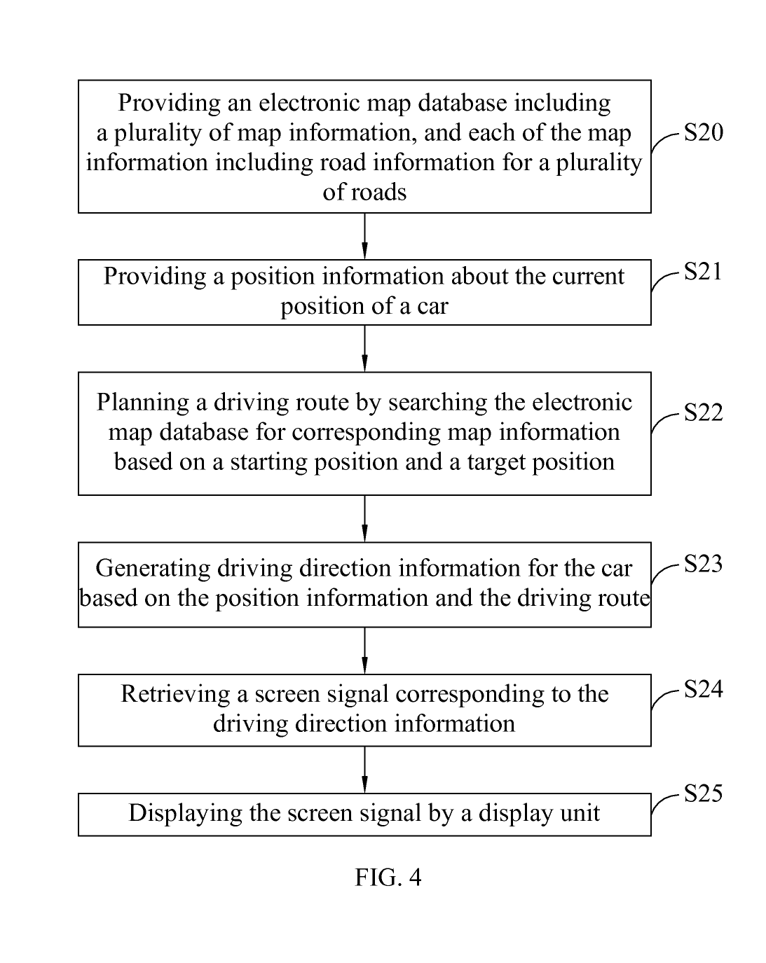

Please refer to FIG. 4 that is a flowchart showing the steps included in a second embodiment of a car navigation method with direction warning according to the present invention. According to this second car navigation method, the driver can recognize a different angle contained between the current driving road and the next road by viewing different screen signals. The method is applicable to a car navigation system with direction warning, which includes a storage unit, a screen control module, a display unit, a satellite positioning module, a route planning unit, and a navigation unit. The car navigation method with direction warning in the second embodiment includes the following steps:

providing an electronic map database including a plurality of map information, and each of the map information including road information for a plurality of roads (S20);

providing a position information about the current car position (S21);

planning a driving route by searching the electronic map database for corresponding map information based on a starting position and a target position (S22);

generating driving direction information for the car based on the position information and the driving route (S23);

retrieving a screen signal corresponding to the driving direction information (S24); and

outputting the screen signal by the display unit (S25).

Accordingly, based on an angle contained between a current driving road and a next road, the navigation unit can retrieve from the screen control module a corresponding screen signal, which may, for example, cause a screen to flash, to change in brightness, or to change in color, and displays the screen signal by the display unit, which may be, for example, a touch screen, so as to remind the driver to slow down and be prepared for a next turn. By displaying different screen signals to remind the driver of different driving directions, there is more fun in using the car navigation system of the present invention.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A car navigation system with direction warning, comprising:
a storage unit having an electronic map database stored therein, the electronic map database including a plurality of map information, each of the map information including road information for a plurality of roads;
a direction sound module for providing a plurality of direction sound information, each of the direction sound information being based on a different direction and each of the directions matching a sound signal;
an output unit for outputting the sound signals;
a satellite positioning module for providing a position information about a current car position;
a route planning unit for planning a driving route by searching the electronic map database for corresponding map information based on a starting position and a target position; and
a navigation unit for generating driving direction information for the car based on the position information and the driving route, retrieving the sound signal corresponding to the driving direction information, and outputting the sound signal by the output unit.

2. The car navigation system with direction warning as claimed in claim 1, wherein the sound signal includes a music file.

3. A car navigation system with direction warning, comprising:
a storage unit having an electronic map database stored therein, the electronic map database including a plurality of map information, each of the map information including road information for a plurality of roads;
a screen control module for providing a plurality of screen control information, each of the screen control information being based on a different direction, and each of the directions matching a screen signal;
a display unit for displaying the screen signals;
a satellite positioning module for providing a position information about a current car position;
a route planning unit for planning a driving route by searching the electronic map database for corresponding map information based on a starting position and a target position; and
a navigation unit for generating driving direction information for the car based on the position information and the driving route, retrieving the screen signal corresponding to the driving direction information, and displaying the screen signal by the display unit.

4. The car navigation system with direction warning as claimed in claim 3, wherein the screen signal is able to cause a screen to flash, to change in brightness, or to change in color.

5. A car navigation method with direction warning, comprising the steps of:
providing an electronic map database including a plurality of map information, and each of the map information including road information for a plurality of roads;
providing a position information about a current car position;
planning a driving route by searching the electronic map database for corresponding map information based on a starting position and a target position;
generating driving direction information for the car based on the position information and the driving route;
retrieving a sound signal corresponding to the driving direction information; and
outputting the sound signal by an output unit.

6. The car navigation method with direction warning as claimed in claim 5, wherein the sound signal includes a music file.

7. A car navigation method with direction warning, comprising the steps of:
providing an electronic map database including a plurality of map information, and each of the map information including road information for a plurality of roads;
providing a position information about a current car position;
planning a driving route by searching the electronic map database for corresponding map information based on a starting position and a target position;
generating driving direction information for the car based on the position information and the driving route;
retrieving a screen signal corresponding to the driving direction information; and
displaying the screen signal by a display unit.

8. The car navigation method with direction warning as claimed in claim 7, wherein the screen signal is able to cause a screen to flash, to change in brightness, or to change in color.
